(19) United States
(12) Patent Application Publication
(10) Pub. No.: US 2007/0218237 A1
(43) Pub. Date: Sep. 20, 2007

(54) Reversible Closure System for Sealing Articles Such as Pouches, Bags, Packs or the Like, Having Two Bonding Strips

(75) Inventors: Axel Burmeister, Buchholz (DE); Christoph Nagel, Hamburg (DE); Franziska Zmarsly, Hamburg (DE)

Correspondence Address: NORRIS, MCLAUGHLIN & MARCUS, PA, 875 THIRD AVENUE, 18TH FLOOR, NEW YORK, NY, 10022, US

(73) Assignee: tesa AG, Hamburg (DE)

(21) Appl. No.: 11/470,674

(22) Filed: Sep. 7, 2006

(30) Foreign Application Priority Data
Mar. 16, 2006 (DE) 10 2004 037 910.6

(51) Int. Cl. B32B 33/00

(52) U.S. Cl. 428/40.1

(57) ABSTRACT

Reversible closure system for sealing articles such as pouches, bags, packs or the like, having two bonding strips, each having a top and a bottom face, the bonding strips each having a carrier whose bottom face is coated with an adhesive, the adhesive containing expanded microballoons in a fraction of 1% to 40%, in particular 5% to 30%, very particularly 10% to 20% by weight, the top face of each of the bonding strips being located on the article to be sealed, and, to seal the article, the bottom faces of each of the two bonding strips being married.

The invention describes a reversible closure system for sealing articles such as pouches, bags, packs or the like, having two bonding strips.

For the reversible sealing of articles such as pouches, bags, packs or the like there exist different technical solutions, for instance hook and loop closures, ridge and groove closures, magnets, needles, suction cups or reversible adhesives on sealing labels (for sealing packs of tissues, for example).

The latter have the great disadvantage that the adhesive used on the sealing labels bonds just as well to any substrates as to the pack itself. As a result of this, with the pack opened, small pieces of dirt stick to the label, leading to a marked reduction in the bond strength. Ultimately the pack can no longer be sealed, when the entire adhesive area has become contaminated with dirt.

DE 21 05 877 C1 presents an adhesive tape composed of a carrier which is coated on at least one side with a microcellular pressure-sensitive adhesive and whose adhesive layer comprises a nucleator, the cells of the adhesive layer being closed and being completely distributed in the adhesive layer.

DE 40 29 896 A1 describes a double-sided self-adhesive tape which has no carrier but comprises a pressure-sensitive adhesive layer containing solid glass microballs.

EP 0 257 984 A1 discloses adhesive tapes which on a carrier layer have an adhesive coating on at least one side. Within this adhesive coating there are polymer beads, which in turn comprise a liquid composed of hydrocarbons. At elevated temperatures the polymer beads exhibit a propensity to expand.

The object on which the invention is based is that of providing a closure system which does not have the disadvantages of the prior art, or at least not to the same extent, and which in particular ensures secure, long-lasting and reversible sealing of articles such as pouches, bags and packs, without having a tendency to become contaminated with dirt when opened.

To achieve this objective the invention proposes a reversible closure system for sealing articles such as pouches, bags, packs or the like, having two bonding strips, each having a top and a bottom face,
the bonding strips each having a carrier whose bottom face is coated with an adhesive,
this adhesive containing expanded microballoons in a fraction of 1% to 40%, in particular 5% to 30%, very particularly 10% to 20% by weight,
the top face of each of the bonding strips being located on the article to be sealed, and,
to seal the article, the bottom faces of each of the two bonding strips being married.

Suitable adhesives include all known solvent-based self-adhesive compounds or aqueous pressure-sensitive adhesives, especially rubber-based and acrylate-based pressure-sensitive adhesives.

The adhesive is advantageously selected from the group of the natural rubbers or of the synthetic rubbers or is composed of any desired blend of natural rubbers and/or synthetic rubbers, the natural rubber or rubbers being selectable in principle from all available grades such as, for example, crepe, RSS, ADS, TSR or CV grades, depending on required purity and viscosity, and the synthetic rubber or rubbers being selectable from the group of randomly copolymerized styrene-butadiene rubbers (SBR), butadiene rubbers (BR), synthetic polyisoprenes (IR), butyl rubbers (IIR), halogenated butyl rubbers (XIIR), acrylate rubbers (ACM) and/or blends thereof.

Furthermore, and preferably, the processing properties of the adhesive may be improved by admixing it with thermoplastic elastomers in a weight fraction of 10% to 50% by weight, based on the total elastomer fraction. As representatives mention may be made at this point, in particular, of the particularly compatible styrene-isoprene-styrene (SIS) and styrene-butadiene-styrene (SBS) types.

As tackifying resins it is possible to use the tackifier resins which are known and which have been described in the literature. Representatives that may be mentioned include the rosins, their disproportionated, hydrogenated, polymerized, esterified derivatives and salts, the aliphatic and aromatic hydrocarbon resins, terpene resins and terpene-phenolic resins. Any desired combination of these and further resins may be used in order to adjust the properties of the resultant adhesive in accordance with what is desired. Explicit reference is made to the depiction of the state of the art in the “Handbook of Pressure Sensitive Adhesive Technology” by Donatas Satas (van Nostrand, 1989).

Plasticizers which can be used are all plasticizing substances known from adhesive tape technology. These include, inter alia, the paraffinic and naphthenic oils, (functionalized) oligomers such as oligobutadienes and oligoisoprenes, liquid nitrile rubbers, liquid terpene resins, animal and vegetable oils and fats, phthalates, and functionalized acrylates.

For the purpose of thermally induced chemical crosslinking it is possible in the context of the process of the invention to use all known thermally activable chemical crosslinkers such as accelerated sulphur systems or sulphur donor systems, isocyanate systems, reactive melamine resins, formaldehyde resins and (optionally halogenated) phenol-formaldehyde resins and/or reactive phenolic resin or diisocyanate crosslinking systems with the corresponding activators, epoxidized polyester resins and acrylate resins, and also combinations of these. The crosslinkers are preferably activated at temperatures above 50° C., in particular at temperatures of 100° C. to 160° C., with very particular preference at temperatures of 110° C. to 140° C. The thermal excitation of the crosslinkers may also take place by means of IR radiation or high-energy alternating fields.

With further preference, therefore, the adhesive is blended with one or more additives such as aging inhibitors, crosslinkers, light stabilizers, ozone protectants, fatty acids, resins, plasticizers and vulcanizing agents, electron beam curing promoters or UV initiators.

Additionally it is preferred if the adhesive is filled with one or more fillers such as carbon black, zinc oxide, silica, silicates and chalk.

In a further advantageous embodiment the adhesive is crosslinked wholly or partly chemically or physically by means of ionizing radiation.

Advantageously the adhesive is an acrylate adhesive from solution or an acrylate dispersion.

With further preference the adhesives are composed of resin-blended acrylate compounds. These are mentioned for example in D. Satas [Handbook of Pressure Sensitive Adhesive Technology, 1989, VAN NOSTRAND REINHOLD, New York].

One advantageous development uses a pressure-sensitive adhesive (PSA)
which is obtainable by free-radical polymerization,
which is composed to the extent of at least 65% by weight of at least one acrylic monomer from the group of compounds of the following general formula:

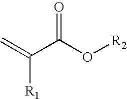

where R₁=H or CH₃ and the radical R₂=H or CH₃ or is selected from the group of branched and unbranched, saturated alkyl groups having 2 to 20 carbon atoms, preferably 4 to 9 carbon atoms, for which the average molecular weight of the pressure-sensitive adhesive is at least 650 000 g/mol, and which, when applied to a carrier, possesses a preferential direction, the refractive index measured in the preferential direction, n_{MD}, being greater than the refractive index measured in a direction perpendicular to the preferential direction, n_{CD}, and where the difference Δn=n_{MD}−n_{CD} amounts to at least 1×10⁻⁵.

Non-exclusive examples of alkyl groups which may find preferred application for the radical R₂ include butyl, pentyl, hexyl, heptyl, octyl, isooctyl, 2-methylheptyl, 2-ethylhexyl, nonyl, decyl, dodecyl, lauryl, or stearyl(meth)acrylate or (meth)acrylic acid.

Also advantageous is a pressure-sensitive adhesive based to an extent of up to 35% by weight on comonomers in the form of vinyl compounds, especially one or more vinyl compounds selected from the following group: vinyl esters, vinyl halides, vinylidene halides, nitriles of ethylenically unsaturated hydrocarbons. For the purposes of this utility, acrylic compounds with functional groups are also embraced by the term “vinyl compound”. Vinyl compounds of this kind containing functional groups are maleic anhydride, styrene, styrenic compounds, vinyl acetate, (meth)acrylamides, N-substituted (meth)acrylamides, β-acryloyloxypropionic acid, vinylacetic acid, fumaric acid, crotonic acid, aconitic acid, dimethylacrylic acid, trichloroacrylic acid, itaconic acid, vinyl acetate, hydroxyalkyl(meth)acrylate, amino-containing (meth)acrylates, hydroxyl-containing (meth)acrylates, especially 2-hydroxyethyl(meth)acrylate, 2-hydroxypropyl (meth)acrylate, and/or 4-hydroxybutyl(meth)acrylate, and double-bond-functionalized photoinitiators; the above listing is only exemplary and not exhaustive.

For the pressure-sensitive adhesives it is especially advantageous if the composition of the corresponding monomers is chosen such that the resultant adhesives possess pressure-sensitive adhesion properties in accordance with D. Satas [Handbook of Pressure Sensitive Adhesive Technology, 1989, VAN NOSTRAND REINHOLD, New York]. For this purpose the glass transition temperature of the acrylate pressure-sensitive adhesive should be situated, for example, below 25° C.

The pressure-sensitive adhesives employed for the utility, particularly the polyacrylate pressure-sensitive adhesives praised above for their advantage, are prepared preferably by a free-radically initiated polymerization. One process very suitable for this purpose is distinguished by the following steps:
polymerization of a mixture comprising at least one vinyl-, acryloyl- or methacryloyl-based monomer or a combination of these monomers, the average molecular weight of the resultant polymers being situated above 650 000 g/mol,
subsequent extrusion coating of the polymer composition,
subsequent crosslinking of the polymer composition on the carrier by irradiation with electron beams.

The free radical polymerization can be conducted in the presence of an organic solvent or in the presence of water, or in mixtures of organic solvents and water, or in bulk. It is preferred to use as little solvent as possible. Depending on conversion and temperature, the polymerization time amounts to between six and 48 h. In the case of solution polymerization the solvents used are preferably esters of saturated carboxylic acids (such as ethyl acetate), aliphatic hydrocarbons (such as n-hexane or n-heptane), ketones (such as acetone or methyl ethyl ketone), special-boiling-point spirit, or mixtures of these solvents. For polymerization in aqueous media or in mixtures of organic and aqueous solvents, the emulsifiers and stabilizers known to the person skilled in the art for this purpose are added to the polymerization. Polymerization initiators used are customary radical-forming compounds such as peroxides, azo compounds and peroxosulfates, for example. Initiator mixtures, too, can be used. During the polymerization it is possible to use further regulators to lower the molecular weight and to reduce the polydispersity. As polymerization regulators it is possible, for example, to use alcohols and ethers. The molecular weight of the acrylate pressure-sensitive adhesives lies advantageously between 650 000 and 2 000 000 g/mol, more preferably between 700 000 and 1 000 000 g/mol.

In a further procedure the polymerization is carried out in polymerization reactors which are generally provided with a stirrer, two or more feed vessels, reflux condenser, heating and cooling and are equipped for operation under an N₂ atmosphere and superatmospheric pressure.

Following the polymerization in solvent the polymerization medium can be removed under reduced pressure, this operation being conducted at elevated temperatures, in the range from 80 to 150° C., for example. The polymers can then be used in the solvent-free state, in particular as hotmelt pressure-sensitive adhesives. In some cases it is also advantageous to prepare the polymers of the invention without solvent.

To prepare the acrylate PSAs the polymers can be given a conventional modification. For example, tackifying resins, such as terpene, terpene-phenolic, C₅, C₉ and C₅/C₉ hydrocarbon, pinene and indene resins or rosins, alone or in combination with one another, can be added. It is also possible, furthermore, to use plasticizers, various fillers (for example fibers, carbon black, zinc oxide, titanium dioxide, solid microballs, solid or hollow glass balls, silica, silicates, chalk, blocking-free isocyanates), aging inhibitors, light stabilizers, ozone protectants, fatty acids, plasticizers, nucleators and/or accelerants as additives. Crosslinkers and crosslinking promoters can also be mixed in. Examples of suitable crosslinkers for electron beam crosslinking are difunctional or polyfunctional acrylates, difunctional or polyfunctional isocyanates or difunctional or polyfunctional epoxides.

In a further advantageous embodiment the adhesive comprising unexpanded microballoons has a thickness of 5 μm to 200 μm, in particular 10 μm to 100 μm.

In a further advantageous embodiment the adhesive comprising expanded microballoons has a thickness of 20 μm to 500 μm.

It has further been found to be preferred if the carrier has adhesion promoters in order to improve the adhesion of the adhesives.

In a further advantageous embodiment the carrier is a polymeric film, paper, woven fabric, nonwoven, release paper or release film.

As the carrier material for the adhesive tape it is possible to use all known textile carriers such as wovens, knits or nonwoven webs; the term “web” embraces at least textile sheetlike structures in accordance with EN 29092 (1988) and also stitchbonded nonwovens and similar systems.

It is likewise possible to use spacer fabrics, including wovens and knits, with lamination.

Spacer fabrics of this kind are disclosed in EP 0 071 212 B1. Spacer fabrics are matlike layer structures comprising a cover layer of a fiber or filament fleece, an underlayer and individual retaining fibers or bundles of such fibers between these layers, said fibers being distributed over the area of the layer structure, being needled through the particle layer, and joining the cover layer and the underlayer to one another. As an additional though not mandatory feature, the retaining fibers in accordance with EP 0 071 212 B1 comprise inert mineral particles, such as sand, gravel or the like, for example. The retaining fibers needled through the particle layer hold the cover layer and the underlayer at a distance from one another and are joined to the cover layer and the underlayer. Spacer wovens or spacer knits are described, inter alia, in two articles, namely
an article from the journal kettenwirk-praxis 3/93, 1993, pages 59 to 63,
“Raschelgewirkte Abstandsgewirke” [Raschel-knitted spacer knits] and
an article from the journal kettenwirk-praxis 1/94, 1994, pages 73 to 76,
“Raschelgewirkte Abstandsgewirke”,
   the content of said articles being included here by reference and being part of this disclosure and invention.

Suitable nonwovens include, in particular, consolidated staple fiber webs, but also filament webs, meltblown webs, and spunbonded webs, which generally require additional consolidation. Known consolidation methods for webs are mechanical, thermal, and chemical consolidation. Whereas with mechanical consolidations the fibers can mostly be held together purely mechanically by entanglement of the individual fibers, by the interlooping of fiber bundles or by the stitching-in of additional threads, it is possible by thermal and by chemical techniques to obtain adhesive (with binder) or cohesive (binderless) fiber-fiber bonds. Given appropriate formulation and an appropriate process regime, these bonds may be restricted exclusively, or at least predominantly, to the fiber nodal points, so that a stable, three-dimensional network is formed while retaining the loose open structure in the web.

Webs which have proven particularly advantageous are those consolidated in particular by overstitching with separate threads or by interlooping.

Consolidated webs of this kind are produced, for example, on stitchbonding machines of the “Malifleece” type from the company Karl Meyer, formerly Malimo, and can be obtained from, inter alia, the companies Naue Fasertechnik and Techtex GmbH. A Malifleece is characterized in that a cross-laid web is consolidated by the formation of loops from fibers of the web. The carrier used may also be a web of the Kunit or Multiknit type. A Kunit web is characterized in that it originates from the processing of a longitudinally oriented fiber web to form a sheetlike structure which has the heads and legs of loops on one side and, on the other, loop feet or pile fiber folds, but possesses neither threads nor prefabricated sheetlike structures. A web of this kind has been produced, inter alia, for many years, for example on stitchbonding machines of the “Kunitylies” type from the company Karl Mayer. A further characterizing feature of this web is that, as a longitudinal-fiber web, it is able to absorb high tensile forces in the longitudinal direction. The characteristic feature of a Multiknit web relative to the Kunit is that the web is consolidated on both the top and bottom sides by virtue of the double-sided needle punching.

Finally, stitchbonded webs as an intermediate are also suitable for forming an inventive cover and an adhesive tape of the invention. A stitchbonded web is formed from a nonwoven material having a large number of stitches extending parallel to one another. These stitches are brought about by the incorporation, by stitching or knitting, of continuous textile threads. For this type of web, stitchbonding machines of the “Maliwatt” type from the company Karl Mayer, formerly Malimo, are known.

Also particularly advantageous is a staple fiber web which is mechanically preconsolidated in the first step or is a wet-laid web laid hydrodynamically, in which between 2% and 50% of the web fibers are fusible fibers, in particular between 5% and 40% of the fibers of the web.

A web of this kind is characterized in that the fibers are laid wet or, for example, a staple fiber web is preconsolidated by the formation of loops from fibers of the web or by needling, stitching or air-jet and/or water-jet treatment. In a second step, thermofixing takes place, with the strength of the web being increased again by the melting or partial melting of the fusible fibers.

Starting materials envisaged for the textile carrier include, in particular, polyester, polypropylene, viscose or cotton fibers. The present invention is, however, not restricted to said materials; rather it is possible to use a large number of other fibers to produce the web, this being evident to the skilled worker without any need for inventive activity.

Suitable carriers also include those composed of paper, of a laminate or of a film (for example PP, PE, PET, PA, PU).

In a further advantageous embodiment the polymeric film has a thickness of 12 μm to 100 μm, in particular 23 μm to 50 μm.

The microballoons are elastic, thermoplastic hollow balls which have a polymer shell. These balls are filled with low-boiling liquids or liquefied gas. Particularly suitable shell polymers are acrylonitrile, PVDC, PVC or acrylates. Suitable low-boiling liquids include hydrocarbons such as the lower alkanes, pentane for example; suitable liquefied gases include chemicals such as isobutane. Particularly advantageous properties become apparent when the microballoons have a diameter at 25° C. of 3 μm to 40 μm, in particular 5 μm to 20 μm. As a result of the effect of heat, the capsules undergo irreversible, three-dimensional expansion. Expansion has come to an end when the internal and external pressures compensate one another. Hence a closed-cell foam is obtained which is notable for good flow-on behaviour and high forces of resilience.

After the thermal expansion as a result of elevated temperature greater than 70° C., the microballoons advantageously have a diameter of 10 μm to 200 μm, in particular 40 μm to 100 μm.

With preference, with the reversible closure system of the invention, the two bonding strips are fastened by means of a self-adhesive compound, a heat-sealing compound, a thread or a liquid adhesive to the article to be sealed.

With particular advantage the closure system of the invention can be used for sealing articles such as pouches, bags, packs or the like.

Advantages of the closure system of the invention are that pouches, bags, packs can be sealed securely and long-lastingly on the basis of the high bonding forces of the two bonding strips to one another. In the opened state, in contrast, there is virtually no dirt contamination; the bonding strips do not exhibit adhesion to other surfaces.

Further advantages are the reversibility of the adhesive bond and the replacement of expensive hook and loop closures.

The intention of the text below is to describe the invention in greater detail by means of a number of examples, without thereby wishing to subject the invention to any unnecessary restriction.

Description of the Measurement Methods:

| Bond strength: | Samples: | 20 mm wide |
|---|---|---|
| | | 200 mm long |
| | Measuring speed: | 300 mm/min |
| Release force: | on foamed test specimen | |
| | Samples: | 20 mm wide |
| | | 200 mm long |

| | |
|---|---|
| 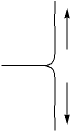 | laminate to one another and apply gentlefinger pressure |

Measurement cycle:
a) 2 × measurement: only gentle pressure applied
b) 2 × measurement: roll over 5 × with 4 kg
Measuring speed: 300 mm/min
Time: immediately/after 18 d

| | |
|---|---|
| Dynamic tensile force: | on foamed test specimens |
| | speed: 50 mm/min |
| | duplicate determination |

| | | |
|---|---|---|
| 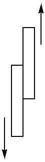 | Samples: | 20 mm wide200 mm long |

Measurement cycle:
1 × measurement: 4 cm² bond overlap subjected to weight of
1 kg for 5 seconds
1 × measurement: after parting, apply finger pressure again
1 × measurement: after parting, apply finger pressure again

### EXAMPLE 1

### Natural Rubber-Based Adhesive with 10% Microballoon Content

Formula for self-adhesive natural rubber compound:

| | % by weight |
|---|---|
| natural rubber V145 | 44 |
| Mikrosohl chalk | 10 |
| Hercurez C resin | 44 |
| Ageing inhibitor (Sontal) | 0.6 |
| MBI (mercaptobenzimidazole) | 0.4 |
| TiO₂ | 1 |

The calculated and weighed natural rubber compound is introduced into the Z-kneader, after which ⅓ of the required benzine is added (do not use the whole amount at once, since otherwise the natural rubber compound will not dissolve fully, and therefore lumps will be formed). The compound is kneaded for approximately 30 minutes. When the compound has dissolved thoroughly, homogeneously, the next third is poured in. After a further half an hour the remainder of the solvent is supplied.

When calculating the microballoon fraction it should also be borne in mind that the microballoons have been mixed with 30% of benzine in order not to form dust any longer. At the end the microballoons are kneaded under the compound, but only for about 15 minutes, since excessive kneading might possibly destroy the microballoons.

Subsequently the adhesive is applied at 13 g/m² to the carrier and dried at a maximum of 70° C. in order to avoid premature foaming.

With a storage time of 3 minutes at 130° C. the foaming rate is 600%.

Foaming takes place at 100° C. to 150° C., in particular at 130° C. The time and temperature of foaming depend on the target foaming rate.

### Release Force as a Function of Microballoon Content (13 g/m² Coatweight)

| Microballoon content | Release force |
|---|---|
| [%] | [N/cm] |
| 5 | 0.9 |
| 7 | 0.5 |
| 10 | 0.5 |
| 20 | 0.1 |

### Dynamic Tensile Force as a Function of Microballoon Content (13 g/m² Coatweight)

| Microballoon | Dynamic tensile force | | |
|---|---|---|---|
| content | [N/cm] | | |
| [%] | 1 | Repetition 2 | Repetition 3 |
| 5 | 35.7 | 25.5 | 18.2 |
| 7 | 30.5 | 26.9 | 24.7 |
| 10 | 35.1 | 34.1 | 37.7 |
| 20 | 0.8 | 4.7 | 8.8 |

### Bond Strength as a Function of Microballoon Content (13 g/m² Coatweight)

| | |
|---|---|
| Microballoon | Bond strength to |
| content | [N/cm] |

| [%] | Steel | Glass | Smooth bead | Rough bead |
|---|---|---|---|---|
| 5 | 0.3 | 0.3 | 0.2 | 0.2 |
| 7 | 0 | 0 | 0 | 0 |
| 10 | 0 | 0 | 0 | 0 |
| 20 | 0 | 0 | 0 | 0 |

### EXAMPLE 2

### Acrylate-Based Adhesive with 15% Microballoon Content

The following monomer mixtures (amounts in % by weight) are copolymerized in solution. The polymerization batches are composed of 60 to 80% by weight of the monomer mixtures and also of 20% to 40% by weight of solvents such as benzine 60/95 and acetone.

The solutions, in standard reaction vessels made of glass or steel (with reflux condenser, anchor stirrer, temperature measurement unit and gas inlet tube), are first freed from oxygen, by flushing with nitrogen, and then heated at boiling.

The polymerization is initiated by addition of 0.1% to 0.4% by weight of a peroxide initiator or azo initiator that is customary for free-radical polymerization, such as dibenzoyl peroxide or azobisisobutyronitrile, for example. During the polymerization time of about 20 hours, dilution takes place where appropriate a number of times with further solvent, depending on the increase in viscosity, so that the finished polymer solutions have a solids content of between 25% to 65% by weight.

Described below by way of examples are formulas of compound in combination with appropriately suitable types of crosslinking, and also the effects brought about as a result of foaming.

### Acrylate, Chelate Crosslinking, Blending

A compound with the following monomer composition is prepared:

| | % by weight |
|---|---|
| 2-Ethylhexyl acrylate | 21 |
| n-Butyl acrylate | 21 |
| tert-Butyl acrylate | 50 |
| Acrylic acid | 8 |

Based on the polymer fraction, the compound is blended with 0.2% by weight of titanium chelate and 15% by weight of microballoons (FQ 2134, Follmann), coated at about 35 g/m² onto a polymeric film, and dried at 60 to 70° C.

The material is subsequently foamed at 130° C. for 3 minutes.

The foaming rate is 600%.

### Release Force as a Function of Microballoon Content (35 g/m² Coatweight)

| MB content | Release force |
|---|---|
| [%] | [N/cm] |
| 10 | 2.5 |
| 15 | 0.6 |
| 20 | 0.1 |

### Adhesive Properties of Specimens with Different Crosslinker Content and 15% Microballoon Content

| | | | | Tensile strength | | |
|---|---|---|---|---|---|---|
| | | BS | Release | [N/cm] | | |
| Crosslinker | BS steel | glass | force | | 2 | |
| content [%] | [N/cm] | [N/cm] | [N/cm] | 1 | repetition | 3 repetition |
| 0.2 | 0.3 | 0.2 | 0.4 | 30 | 31 | 29 |
| 0.4 | 0.2 | 0.0 | 0.2 | 28 | 26 | 26 |
| 0.6 | 0.0 | 0.0 | 0.9 | 12 | 7 | 14 |

What is claimed is:

1. Reversible closure system for sealing an article, said reversible closure system comprising two bonding strips, the bonding strips each having a top and a bottom face, the bonding strips each having a carrier whose bottom face is coated with an adhesive, the adhesive comprising expanded microballoons in a fraction of 1% to 40% by weight, the top face of each of the bonding strips being located on the article to be sealed, and the bottom faces of each of the two bonding strips being capable of being married to seal the article.

2. Reversible closure system according to claim 1, wherein the adhesive is composed of natural rubber, of acrylonitrile-butadiene rubber, of butyl rubber, of styrene-butadiene rubber or of a blend of the said rubbers or the adhesive is an acrylate adhesive from solution or an acrylate dispersion.

3. Reversible closure system according to claim 1 wherein the adhesive is blended with one or more additives selected from the group consisting of aging inhibitors, crosslinkers, light stabilizers, ozone protectants, fatty acids, resins, plasticizers, vulcanizing agents, electron beam curing promoters and UV initiators.

4. Reversible closure system according to claim 1, wherein the adhesive is filled with one or more fillers selected from the group consisting of carbon black, zinc oxide, silica, silicates and chalk.

5. Reversible closure system according to claim 1, wherein the carrier layer is crosslinked wholly or partly chemically or physically by means of ionizing radiation.

6. Reversible closure system according claim 1, wherein the adhesive comprising expanded microballoons has a thickness of 20 μm to 500 μm.

7. Reversible closure system according to claim 1, wherein the carrier has adhesion promoters in order to improve the adhesion of the adhesives.

8. Reversible closure system according to claim 1, wherein the carrier is selected from the group consisting of a polymeric film, a paper, a woven fabric, a nonwoven, a release paper or a release film.

9. Reversible closure system according to claim 1, wherein the microballoons at 25° C. have a diameter of 3 μm to 40 μm, and/or after temperature exposure, have a diameter of 5 μm to 200 μm.

10. Reversible closure system according to claim 1, wherein the two bonding strips are fastened by means of a self-adhesive compound, a heat-sealing compound, a thread or a liquid adhesive to the article to be sealed.

11. A method for sealing an article, said method comprising providing an article comprising a reversible closure system according to claim 1, and marrying the bottom faces of the two bonding strips to seal the article.

12. Method according to claim 11, wherein the article is a pouch, bag, pack or the like.
